(19) United States
(12) Patent Application Publication
(10) Pub. No.: US 2025/0347506 A1
(43) Pub. Date: Nov. 13, 2025

(54) STRAIN GAUGE AND SENSOR

(71) Applicant: Alps Alpine Co., Ltd., Tokyo (JP)

(72) Inventors: Yosuke IDE, Niigata-ken (JP); Masakazu SERA, Niigata-ken (JP); Mitsuji YANO, Niigata-ken (JP)

(21) Appl. No.: 19/277,944

(22) Filed: Jul. 23, 2025

Related U.S. Application Data
(63) Continuation of application No. PCT/JP2024/000415, filed on Jan. 11, 2024.

(30) Foreign Application Priority Data
Feb. 16, 2023 (JP) 2023-022827

(51) Int. Cl. G01B 7/16

(52) U.S. Cl. CPC G01B 7/16

(57) ABSTRACT

A strain gauge includes a strain resistor having a multilayer structure including a first layer composed of a Cr—Fe alloy and a second layer composed of Cr or a Cr-M alloy of Cr and M, M being at least one element selected from the group consisting of Fe, Nb, Mo, Ta, and W. The first layer and the second layer may each have a bcc structure. The amount of Fe added in the Cr—Fe alloy constituting the first layer may be 0.8 at. % or more and 11.2 at. % or less. When the second layer is composed of a Cr-M alloy but with M being other than Fe, the amount of M added may be more than 0 at. % and 7.7 at. % or less.

### CLAIM OF PRIORITY

This application is a Continuation of International Application No. PCT/JP2024/000415 filed on Jan. 11, 2024, which claims benefit of Japanese Patent Application No. 2023-022827 filed on Feb. 16, 2023. The entire contents of each application noted above are hereby incorporated by reference.

### BACKGROUND OF THE INVENTION

### 1. Field of the Invention

The present invention relates to a strain gauge and a sensor.

### 2. Description of the Related Art

There is a known strain gauge that attaches to a measurement object (strain-generating body) to detect strain in the measurement object. An example of a constituent material for a strain gauge is a strain resistor that changes its resistance with changes in volume in response to an applied external force, specifically, a metal material that contains Ni, Cr, Cu, etc. The strain resistor is, for example, formed in a film shape on a substrate and is given a desired pattern, such as a meandering pattern, by photolithography and etching, etc.

Since a strain resistor oftentimes has a large absolute temperature coefficient of resistance, for example, Japanese Unexamined Patent Application Publication No. 2019-204874 proposes an example of a thin-film resistor for a strain gauge, the thin-film resistor having a gauge factor of 10 or more and a temperature coefficient of resistance of ±100 [ppm/° C.] or less, in which the thin-film resistor contains chromium (Cr), oxygen (O), and nitrogen (N) and is represented by general formula Cr_{100-x-y}OₓN_{y} where compositional ratios x and y in terms of at. % satisfy the relationship 3.0≤x≤15.0 and the relationship 1.0≤y≤10.0, and the chromium has a (110) bcc structure.

International Publication No. 2001-004594 discloses a strain gauge characterized by having a multilayer structure including a first layer made of a material having a positive temperature coefficient of resistance and a second layer made of a material having a negative temperature coefficient of resistance.

According to the thin-film resistor disclosed in Japanese Unexamined Patent Application Publication No. 2019-204874, the heat treatment included in its production process is optimized to control orientation of chromium and to thereby decrease the temperature coefficient of resistance TCR. This means that the thin-film resistor disclosed in Japanese Unexamined Patent Application Publication No. 2019-204874 has the temperature coefficient of resistance TCR that is easily affected by variations in the production process. Thus, according to the method disclosed in Japanese Unexamined Patent Application Publication No. 2019-204874, it has not been easy to stably produce a thin-film resistor that has a high gauge factor Gf and is insusceptible to temperature changes. Meanwhile, according to the strain gauge disclosed in International Publication No. 2001-004594, a gauge factor of less than 5 is the only result achieved in the specific examples disclosed in Examples, and thus this cannot meet the recent requirements for a gauge factor of 10 or more.

### SUMMARY OF THE INVENTION

The present invention provides a strain gauge that has a gauge factor Gf of 10 or more and that is insusceptible to temperature changes, and a sensor that includes such a strain gauge.

An aspect of the present invention provides a strain gauge including a strain resistor having a multilayer structure including a first layer composed of a Cr—Fe alloy and a second layer composed of Cr or a Cr-M alloy of Cr and M (hereinafter may also be referred to as “element M”), M being at least one element selected from the group consisting of Fe, Nb, Mo, Ta, and W.

A strain resistor composed of a Cr—Fe alloy can achieve a gauge factor Gf of 10 or more and a negative temperature coefficient of resistance TCR over a wide compositional range. Thus, it becomes possible to obtain a strain gauge that has a gauge factor Gf of 10 or more and a temperature coefficient of resistance TCR in the range of ±1000 ppm/° C. by stacking a first layer composed of this Cr—Fe alloy and a second layer composed of a Cr-M alloy or Cr having a positive temperature coefficient of resistance TCR. Moreover, the gauge factor Gf and the temperature coefficient of resistance TCR can be adjusted by changing the thickness balance between these layers while unchanging the compositions of the first layer and the second layer.

In the aforementioned strain gauge, the first layer and the second layer may each have a bcc structure. When the first layer and the second layer each has a bcc structure, the order in which the first layer and the second layer are stacked is not limited, and there is no need to provide an intermediate layer as a diffusion barrier material as in Example 1 of International Publication No. 2001-004594.

In some cases, the amount of Fe added in the Cr—Fe alloy constituting the first layer of the aforementioned strain gauge is preferably 0.8 at. % or more and 11.2 at. % or less. Since the gauge factor Gf (measurement temperature: 25° C.) of the strain resistor composed of a Cr—Fe alloy within this compositional range is 10 or more, the strain gauge that includes the first layer and the second layer also easily achieves a gauge factor Gf of 10 or more.

When the second layer of the strain gauge is composed of a Cr-M alloy (excluding the case where element Mis Fe), the amount of element M added (amount of M added) is preferably more than 0 at. % and 7.7 at. % or less in some cases. Within the range where the gauge factor Gf (measurement temperature: 25° C.) of the strain resistor composed of a Cr-M alloy is 10 or more, a strain gauge that includes the first layer and the second layer also stably achieves a gauge factor Gf of 10 or more. From this viewpoint, the amount of M added is preferably 0.5 at. % or more and 3.5 at. % or less when element M is Ta, is preferably 0.5 at. % or more and 3.5 at. % or less when element M is Nb, is preferably 2 at. % or more and 14 at. % or less when element Mis Mo, and is preferably 1 at. % or more and 12 at. % or less when element Mis W. When element Mis Fe, the temperature coefficients of resistance TCR of the first layer and the second layer preferably have polarities opposite to each other. Specifically, when the amount of Fe added in the Cr—Fe alloy constituting the first layer is 0.8 at. % or more and 11.2 at. % or less and the second layer is composed of a Cr—Fe alloy, the amount of Fe added in the second layer is preferably either more than 0 at. % and less than 0.8 at. %, or more than 11.2 at. % and less than 14.4 at. %.

The aforementioned strain gauge can have a gauge factor Gf of 10 or more and a temperature coefficient of resistance TCR (unit: ppm/° C.) in the range of ±500 ppm/° C. by appropriately setting element M and the thickness balance between the first layer and the second layer.

Another aspect of the present invention provides a sensor that includes a substrate and the strain gauge according to the aforementioned aspect disposed on the substrate, in which the strain gauge is used as detecting means.

### BRIEF DESCRIPTION OF THE DRAWINGS

FIG. 1 is a diagram illustrating one example of a strain sensor according to one embodiment of the present invention;

FIG. 2 is a schematic view of a cross section taken at line II-II in FIG. 1;

FIG. 3 is a graph illustrating the relationship between the gauge factor Gf of strain gauges including strain resistors composed of Cr-M alloys, and the amount of element M added;

FIG. 4 is a graph illustrating the relationship between the temperature coefficient of resistance TCR of the strain gauges composed of Cr-M alloys, and the amount of element M added;

FIG. 5 is a graph illustrating the relationship between the gauge factor Gf and the temperature coefficient of resistance TCR of a strain gauge of Example 1, as a function of the thickness ratio of a first layer;

FIG. 6 is a graph illustrating the relationship between the gauge factor Gf and the temperature coefficient of resistance TCR of a strain gauge of Example 2, as a function of the thickness ratio of a first layer;

FIG. 7 is a graph illustrating the relationship between the gauge factor Gf and the temperature coefficient of resistance TCR of a strain gauge of Example 3, as a function of the thickness ratio of a first layer;

FIG. 8 is a graph illustrating the relationship between the gauge factor Gf and the temperature coefficient of resistance TCR of a strain gauge of Example 4, as a function of the thickness ratio of a first layer;

FIG. 9 is a graph illustrating the relationship between the gauge factor Gf and the temperature coefficient of resistance TCR of a strain gauge of Example 5, as a function of the thickness ratio of a first layer;

FIG. 10 is a graph illustrating the relationship between the gauge factor Gf and the temperature coefficient of resistance TCR of a strain gauge of Example 6, as a function of the thickness ratio of a first layer; and

FIG. 11 is a graph illustrating the relationship between the gauge factor Gf and the temperature coefficient of resistance TCR regarding the strain gauges of Examples 1 to 6.

### DESCRIPTION OF THE PREFERRED EMBODIMENTS

Embodiments of the present invention will now be described with reference to the drawings. Note that, in the description below, the same members are denoted by the same reference signs, and the description of the member that has already been described is omitted to avoid redundancy.

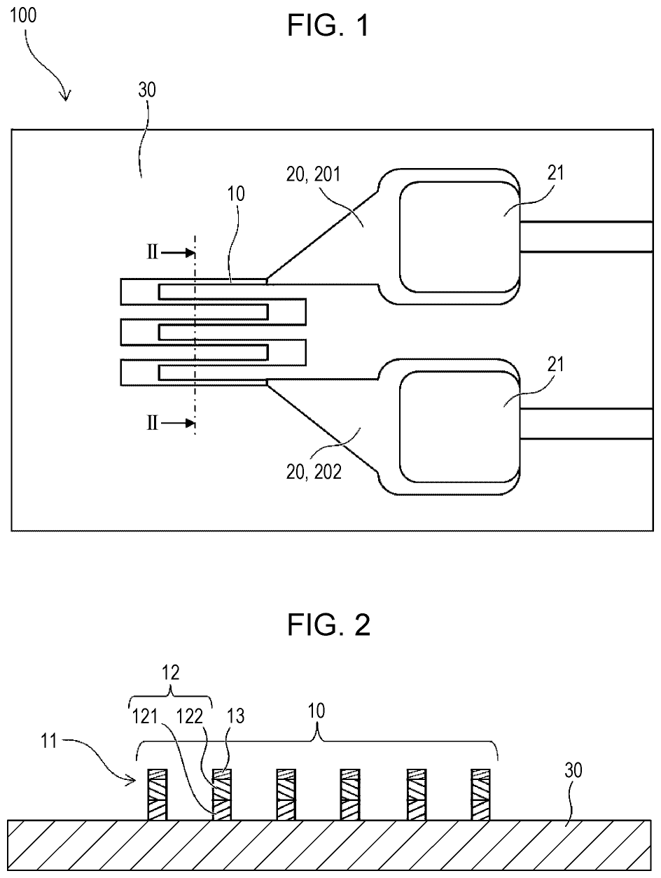

FIG. 1 is a diagram illustrating one example of a strain sensor according to one embodiment of the present invention. As illustrated in FIG. 1, a sensor 100 according to this embodiment includes a strain gauge 10 having a meandering pattern and electrodes 20 for energizing the strain gauge 10. The strain gauge 10 and the electrodes 20 are all formed on a substrate 30. The strain gauge 10 functions as detecting means. The sensor 100 may be a strain sensor that directly measures the strain in the strain gauge 10 on the basis of a signal from the strain gauge 10, may be a deformation/displacement sensor that measures the extent of deformation of a member (strain-generating body) to which the sensor 100 is attached, or may be a sensor that measures any other physical quantity (pressure, speed, acceleration, etc.) on the basis of the extent of deformation of the strain-generating body. Examples of the material constituting the electrodes 20 include, but are not limited to, Cu, Au, and alloys containing Cu and/or Au. The electrodes 20 include a first electrode 201 connected to one end of the strain gauge 10 and a second electrode 202 connected to the other end of the strain gauge 10, and each of the first electrode 201 and the second electrode 202 has a plating layer 21 for enhancing the solder joint strength.

FIG. 2 is a schematic view of a cross section taken at line II-II in FIG. 1. As illustrated in FIG. 2, the strain gauge 10 includes a multilayer body 11 that includes a strain resistor 12 having a multilayer structure including a first layer 121 and a second layer 122 each made of a thin-film strain resistor, and a protection layer 13 that has a portion in contact with the strain resistor 12. The multilayer body 11 forms a meandering pattern. The protection layer 13 is provided as necessary and is optional, and may be composed of, for example, Ta.

The strain resistor 12 has properties to change its resistance value as the length changes in a current-flowing direction in response to application of an external force. Such properties can be quantitatively evaluated by the gauge factor Gf expressed by following equation (A).

Gf=(ΔR/R)/(ΔL/L) (A)

Here, L represents the length (length in the current-flowing direction) in the direction of the flow of the current when no external force is applied to the strain gauge 10 (under no load), ΔL represents the amount of change in length of the strain gauge 10 in the current-flowing direction when an external force is applied to the strain gauge 10 (under load) relative to the length under no load, R represents a resistance value of the strain gauge 10 under no load, and ΔR represents the amount of change in resistance value of the strain gauge 10 under load relative to that under no load.

In this embodiment, the first layer 121 is composed of a Cr—Fe alloy, and the second layer 122 is composed of Cr or a Cr-M alloy that is an alloy of Cr and M (element M) which is at least one element selected from the group consisting of Fe, Nb, Mo, Ta, and W. Due to the presence of this multilayer structure, the strain gauge 10 that includes the strain resistor 12 easily satisfies the requirement that the gauge factor Gf be 10 or more and the temperature coefficient of resistance TCR be in the range of ±1000 ppm/° C.

The crystal structures of the first layer 121 and the second layer 122 are preferably both a bcc structure from the viewpoint of increasing the gauge factor Gf of the strain resistor 12. As such, when both of the first layer 121 and the second layer 122 have a bcc structure, the order in which the first layer 121 and the second layer 122 are stacked is not particularly limited. In other words, in FIG. 2, the first layer 121 is closer to the substrate 30, and when the first layer 121 is formed on the substrate 30, the second layer 122 is formed on the first layer 121. The strain resistor 12 may be formed as such; alternatively, the first layer 121 may be formed on the second layer 122. Furthermore, since both layers have a common crystal structure, there is no need to form a special layer (for example, a crystallinity adjusting layer) between the two layers. The specific resistance of the strain resistor 12 is, for example, but is not limited to, 100 μΩcm or less.

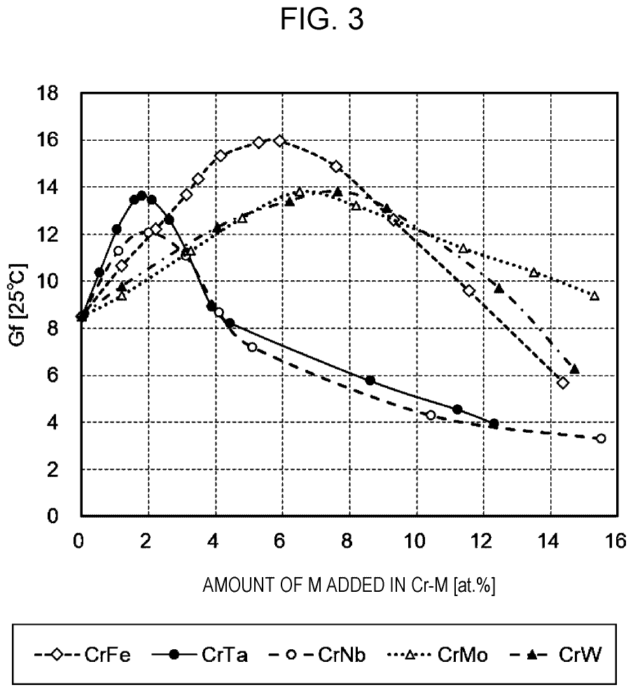

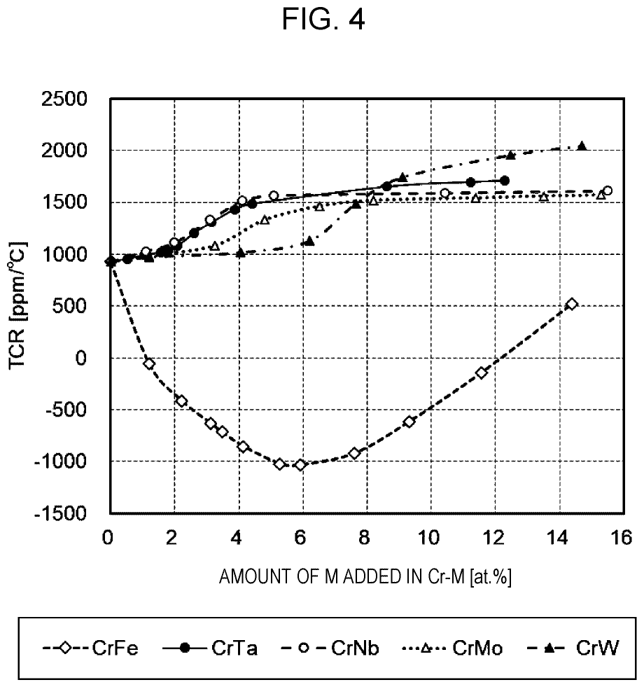

Table 1 indicates the results obtained by measuring the gauge factor Gf (at a measurement temperature of 25° C., the same applies hereinafter) and the temperature coefficient of resistance TCR of strain gauges including strain resistors composed of Cr-M alloys (element M being one of Fe, Ta, Nb, Mo, and W, the same applies hereinafter) with varying amounts of element M added. FIG. 3 is a graph obtained by plotting the results in Table 1 and illustrates the relationship between the gauge factor Gf of a strain gauge that includes a strain resistor composed of a Cr-M alloy and the amount of element M added. FIG. 4 is a graph obtained by plotting the results in Table 1 and illustrates the relationship between the temperature coefficient of resistance TCR of a strain gauge that includes a strain resistor composed of a Cr-M alloy and the amount of element M added.

TABLE 1

| CrFe | | | CrTa | | | CrNb | | | CrMo | | | CrW | | |
|---|---|---|---|---|---|---|---|---|---|---|---|---|---|---|
| Amount | | | Amount | | | Amount | | | Amount | | | Amount | | |
| of Fe | | TCR | of Ta | | TCR | of Nb | | TCR | of Mo | | TCR | of W | | TCR |
| added | | [ppm/ | added | | [ppm/ | added | | [ppm/ | added | | [ppm/ | added | | [ppm/ |
| [at. %] | Gf | ° C.] | [at. %] | Gf | ° C.] | [at. %] | Gf | ° C.] | [at. %] | Gf | ° C.] | [at. %] | Gf | ° C.] |
| 0.0 | 8.5 | 930 | 0.0 | 8.5 | 930 | 0.0 | 8.5 | 930 | 0.0 | 8.5 | 930 | 0.0 | 8.5 | 930 |
| 1.2 | 10.7 | −54 | 0.5 | 10.4 | 957 | 1.1 | 11.3 | 1032 | 1.2 | 9.4 | 983 | 1.2 | 9.8 | 976 |
| 2.2 | 12.2 | −412 | 1.0 | 12.2 | 994 | 2.0 | 12.1 | 1115 | 3.3 | 11.3 | 1087 | 4.1 | 12.3 | 1020 |
| 3.1 | 13.7 | −629 | 1.6 | 13.5 | 1021 | 3.1 | 11.1 | 1329 | 4.8 | 12.7 | 1331 | 6.2 | 13.4 | 1132 |
| 3.5 | 14.3 | −714 | 1.8 | 13.6 | 1034 | 4.1 | 8.7 | 1515 | 6.5 | 13.8 | 1463 | 7.7 | 13.8 | 1489 |
| 4.1 | 15.3 | −854 | 2.1 | 13.5 | 1085 | 5.1 | 7.2 | 1568 | 8.2 | 13.2 | 1519 | 9.1 | 13.1 | 1743 |
| 5.3 | 15.9 | −1021 | 2.6 | 12.6 | 1208 | 10.4 | 4.3 | 1592 | 11.4 | 11.4 | 1543 | 12.5 | 9.7 | 1956 |
| 5.9 | 16.0 | −1034 | 3.1 | 11.3 | 1305 | 15.5 | 3.3 | 1613 | 13.5 | 10.4 | 1561 | 14.7 | 6.3 | 2045 |
| 7.6 | 14.9 | −921 | 3.9 | 8.9 | 1432 | | | | 15.3 | 9.4 | 1572 | | | |
| 9.3 | 12.6 | −618 | 4.4 | 8.2 | 1487 | | | | | | | | | |
| 11.6 | 9.6 | −143 | 8.6 | 5.8 | 1651 | | | | | | | | | |
| 14.4 | 5.7 | 521 | 11.2 | 4.5 | 1697 | | | | | | | | | |
| | | | 12.3 | 4.0 | 1710 | | | | | | | | | |

As illustrated in FIGS. 3 and 4, the Cr—Fe alloy can give a strain gauge 10 that exhibits a gauge factor Gf of 10 or more and a negative temperature coefficient of resistance TCR over a wide compositional range (from about 2 at. % to about 9.5 at. %). Meanwhile, Cr-M alloys other than the Cr—Fe alloy can give a strain gauge 10 that exhibits a gauge factor Gf of 10 or more and a positive temperature coefficient of resistance TCR. The same tendency is observed with Cr used alone. Thus, it becomes possible to easily obtain a strain gauge 10 that has a gauge factor Gf of 10 or more and a temperature coefficient of resistance TCR in the range of +1000 ppm/° C. by stacking a first layer 121 composed of a Cr—Fe alloy and a second layer 122 composed of a Cr-M alloy or Cr.

In the aforementioned strain gauge 10, the amount of Fe added in the Cr—Fe alloy constituting the first layer 121 is preferably 0.8 at. % or more and 11.2 at. % or less in some cases. As illustrated in FIG. 3, when the amount of Fe added in the Cr—Fe alloy is 0.8 at. % or more and 11.2 at. % or less, the gauge factor Gf of the strain gauge 10 is 10 or more; thus, by setting the amount of Fe added to be in this range, the strain gauge 10 can easily have a high gauge factor Gf and easily be made insusceptible to temperature changes. From the viewpoint of stably obtaining a strain gauge 10 that has a high gauge factor Gf and is insusceptible to temperature changes, the amount of Fe added in the Cr—Fe alloy constituting the first layer 121 is preferably 1.2 at. % or more and 9.3 at. % or less in some cases and is more preferably 3.1 at. % or more and 7.6 at. % or less in some cases.

When the second layer 122 is composed of a Cr-M alloy (excluding the case where element M is Fe), the amount of M added in the Cr-M alloy is preferably more than 0 at. % and 7.7 at. % or less in some cases. When the amount of M added in the Cr-M alloy is within this range, the gauge factor Gf exhibits an increasing tendency as shown in FIG. 3 and the temperature coefficient of resistance TCR takes a positive value as shown in FIG. 4 with some of the elements constituting element M; thus, a strain gauge 10 that has a high gauge factor Gf and is insusceptible to temperature changes can be easily obtained. From the viewpoint of stably obtaining a strain gauge 10 that has a high gauge factor Gf and is insusceptible to temperature changes, the amount y of M added is preferably 0.5 at. % or more and 3.5 at. % or less in some cases, more preferably 1.1 at. % or more and 3.1 at. % or less in some cases, and particularly preferably 1.1 at. % or more and 2.1 at. % or less in some cases when element Mis Ta.

From the same viewpoint, the amount y of M added is preferably 0.5 at. % or more and 3.5 at. % or less in some cases, more preferably 0.5 at. % or more and 3.1 at. % or less in some cases, and particularly preferably 1.1 at. % or more and 2.0 at. % or less in some cases when element M is Nb.

From the same viewpoint, the amount y of M added is preferably 2 at. % or more and 14 at. % or less in some cases, more preferably 3.3 at. % or more and 13.5 at. % or less in some cases, and particularly preferably 3.3 at. % or more and 6.5 at. % or less in some cases when element Mis Mo.

From the same viewpoint, the amount y of M added is preferably 1 at. % or more and 12 at. % or less in some cases, more preferably 1.2 at. % or more and 9.1 at. % or less in some cases, and particularly preferably 4.1 at. % or more and 7.7 at. % or less in some cases when element Mis W. When element Mis Ta, the amount y of M added is preferably 0.5 at. % or more and 3.5 at. % or less in some cases and more preferably 0.5 at. % or more and 2.1 at. % or less in some cases.

When element M is Fe, the first layer 121 and the second layer 122 are both composed of a Cr—Fe alloy. In this case, when a strain resistor made of the first layer 121 and a strain resistor made of the second layer 122 are measured separately, the polarities of the temperature coefficient of resistance TCR of the two strain resistors are preferably opposite to each other (when the temperature coefficient of resistance TCR of the first layer 121 is positive, the temperature coefficient of resistance TCR of the second layer 122 is negative, or when the temperature coefficient of resistance TCR of the first layer 121 is negative, the temperature coefficient of resistance TCR of the second layer 122 is positive). Thus, when the first layer 121 and the second layer 122 are both composed of a Cr—Fe alloy, the amount of Fe added in one of the layers is preferably 0.8 at. % or more and 11.2 at. % or less and more preferably 1.2 at. % or more and 11.6 at. % or less, and the amount of Fe added in the other layer is preferably either more than 0 at. % and less than 0.8 at. %, or more than 11.2 at. % and is more preferably either more than 0 at. % and less than 0.8 at. %, or more than 11.2 at. % and less than 14.4 at. %.

The first layer 121 and the second layer 122 constituting the strain resistor 12 of the strain gauge 10 of this embodiment may have any thickness. As indicated by the examples described below, the gauge factor Gf and the temperature coefficient of resistance TCR of the strain gauge 10 can be controlled by adjusting the balance between the thickness of the first layer 121 and the thickness of the second layer 122 (specifically, the thickness ratio of the thickness of the first layer 121 to the thickness of the strain resistor 12). Thus, compared to the case where oxygen (O) and nitrogen (N) are contained in Cr as disclosed in Japanese Unexamined Patent Application Publication No. 2019-204874, there is no need to precisely control the crystal structure. Thus, according to this embodiment, a high-quality strain gauge 10 that has a high gauge factor Gf and is less likely to be affected by the temperature can be obtained without increasing the production load.

It should be noted that, when the first layer 121 and the second layer 122 are excessively thick, the inner stress becomes excessively high and the layers may not be able to maintain the thin-film shape although this depends on the production method. From the viewpoint of securing the shape stability of the strain resistor 12, the thickness of each layer is preferably 300 nm or less in some cases. When the first layer 121 and the second layer 122 are excessively thin, the change in resistance in response to strain becomes excessively small, and the strain resistor 12 may not be able to function properly. From the viewpoint of fulfilling the essential functions of the first layer 121 and the second layer 122, the thickness of each layer is preferably 30 nm or more in some cases.

The method for producing the strain resistor 12 of this embodiment is not particularly limited. As described above, since the strain resistor 12 is composed of an alloy for a strain resistor of this embodiment, the strain resistor 12 can be produced by a known film forming method such as sputtering. When sputtering is employed in the production, alloys having compositions respectively corresponding to the compositions of the first layer 121 and the second layer 122 to be produced may be used as targets, or a target that includes laid-out tiles of pure metals of Cr, Fe, and element M may be used to control the composition of each of the first layer 121 and the second layer 122. Alternatively, two or more targets may be used to perform co-sputtering and the composition of each of the first layer 121 and the second layer 122 may be adjusted by adjusting the amount of the electric power applied to each of the targets. When the first layer 121 and the second layer 122 are both composed of a Cr—Fe alloy, it is efficient in some cases to employ a production method that involves using two or more targets to perform co-sputtering and adjusting the amount of the electric power applied to each of the targets. It should be noted that when films are formed by sputtering, the thickness of each layer can be controlled by administering the film formation time.

When films are formed by sputtering, a common sputtering apparatus may be used, and an inert element such as argon may be used as the atmosphere. Here, the thin-film resistor for a strain gauge disclosed in Japanese Unexamined Patent Application Publication No. 2019-204874 achieves the desired effects (a gauge factor of 10 or more and a temperature coefficient of resistance of ±100 [ppm/° C.] or less) by mixing oxygen molecules (O₂) and nitrogen molecules (N₂) in the atmosphere as the reactive gas components and by performing reactive sputtering while adjusting the amounts of oxygen (O) and nitrogen (N) contained in the formed films. However, a dedicated facility (a mechanism for controlling the amounts of the reactive gas components supplied, such as a mass flow controller) is necessary to conduct reactive sputtering, and even when such a facility is used, it is not easy to strictly adjust the amounts of these elements to be mixed and secure the homogeneity of the composition of the film formed on the substrate. In contrast, the strain resistor 12 of this embodiment does not require adjustment of the amounts of the reactive gas components supplied, and thus films of alloys can be produced by using a common sputtering apparatus. Thus, the strain resistor 12 of this embodiment has excellent quality stability and excellent productivity.

The embodiments described heretofore are described to facilitate the understanding of the present invention, not to limit the present invention. Thus, each of the features disclosed in the aforementioned embodiments is intended to include all design modifications and alterations and equivalents thereof within the technical scope of the present invention. For example, the case where element M includes one or more elements encompasses any case where other elements are also present to an extent that does not substantially affect the effects of the present invention, and a specific example of such a case is a case where other elements become mixed inevitably from the viewpoint of the industrial production.

The present invention will now be specifically described through Examples below.

### EXAMPLES

### Examples 1 to 6

A strain gauge 10 that included a first layer 121 and a second layer 122 was produced by sputtering on a substrate 30 composed of a polyimide film. In all of Examples, the first layer 121 was composed of a Cr—Fe alloy with 5.3 at. % of Fe added thereto. The second layer 122 was composed of Cr in Example 1, a Cr—Ta alloy (amount of Ta added: 1.8 at. %) in Example 2, a Cr—Nb alloy (amount of Nb added: 2.0 at. %) in Example 3, a Cr—Mo alloy (amount of Mo added: 2.1 at. %) in Example 4, a Cr—W alloy (amount of W added: 2.4 at. %) in Example 5, and a Cr—Fe alloy (amount of Fe added: 14.4 at. %) in Example 6.

In each of Examples, as shown in Tables 2 to 7, the thickness of the first layer 121 and the thickness of the second layer 122 were varied. The “thickness ratio” in each of the tables is a ratio of the thickness of the first layer 121 to the thickness of the strain resistor 12.

TABLE 2

| First layer (CrFe) | | | | | |
|---|---|---|---|---|---|
| Amount of | | Second layer (Cr) | Thickness Ratio | | |
| Fe added | Thickness | Thickness | (First Layer Thickness/ | | TCR |
| [at. %] | [nm] | [nm] | Total Thickness) | Gf | [ppm/° C.] |
| 5.3 | 100 | 0 | 1.00 | 15.9 | −1021 |
| ↑ | 75 | 25 | 0.75 | 14.2 | −589 |
| ↑ | 50 | 50 | 0.50 | 12.1 | −67 |
| ↑ | 25 | 75 | 0.25 | 10.4 | 457 |
| ↑ | 0 | 100 | 0.00 | 8.5 | 930 |

TABLE 3

| First layer (CrFe) | | Second layer (CrTa) | | | | |
|---|---|---|---|---|---|---|
| Amount of | | Amount of | | Thickness Ratio | | |
| Fe added | Thickness | Ta added | Thickness | (First Layer Thickness/ | | TCR |
| [at. %] | [nm] | [at. %] | [nm] | Total Thickness) | Gf | [ppm/° C.] |
| 5.3 | 100 | 1.8 | 0 | 1.00 | 15.9 | −1021 |
| ↑ | 75 | ↑ | 25 | 0.75 | 15.4 | −548 |
| ↑ | 50 | ↑ | 50 | 0.50 | 14.8 | −18 |
| ↑ | 25 | ↑ | 75 | 0.25 | 14.3 | 531 |
| ↑ | 0 | ↑ | 100 | 0.00 | 13.6 | 1034 |

TABLE 4

| First layer (CrFe) | | Second layer (CrNb) | | | | |
|---|---|---|---|---|---|---|
| Amount of | | Amount of | | Thickness Ratio | | |
| Fe added | Thickness | Nb added | Thickness | (First Layer Thickness/ | | TCR |
| [at. %] | [nm] | [at. %] | [nm] | Total Thickness) | Gf | [ppm/° C.] |
| 5.3 | 100 | 2.0 | 0 | 1.00 | 15.9 | −1021 |
| ↑ | 75 | ↑ | 25 | 0.75 | 15.1 | −548 |
| ↑ | 50 | ↑ | 50 | 0.50 | 14.2 | 36 |
| ↑ | 25 | ↑ | 75 | 0.25 | 13.1 | 563 |
| ↑ | 0 | ↑ | 100 | 0.00 | 12.1 | 1115 |

TABLE 5

| First layer (CrFe) | | Second layer (CrMo) | | | | |
|---|---|---|---|---|---|---|
| Amount of | | Amount of | | Thickness Ratio | | |
| Fe added | Thickness | Mo added | Thickness | (First Layer Thickness/ | | TCR |
| [at. %] | [nm] | [at. %] | [nm] | Total Thickness) | Gf | [ppm/° C.] |
| 5.3 | 100 | 2.1 | 0 | 1.00 | 15.9 | −1021 |
| ↑ | 75 | ↑ | 25 | 0.75 | 14.7 | −521 |
| ↑ | 50 | ↑ | 50 | 0.50 | 13.4 | 24 |
| ↑ | 25 | ↑ | 75 | 0.25 | 11.8 | 529 |
| ↑ | 0 | ↑ | 100 | 0.00 | 10.2 | 1035 |

TABLE 6

| First layer (CrFe) | | Second layer (CrW) | | | | |
|---|---|---|---|---|---|---|
| Amount of | | Amount of W | | Thickness Ratio | | |
| Fe added | Thickness | added | Thickness | (First Layer Thickness/ | | TCR |
| [at. %] | [nm] | [at. %] | [nm] | Total Thickness) | Gf | [ppm/° C.] |
| 5.3 | 100 | 2.4 | 0 | 1.00 | 15.9 | −1021 |
| ↑ | 75 | ↑ | 25 | 0.75 | 14.7 | −479 |
| ↑ | 50 | ↑ | 50 | 0.50 | 13.6 | 31 |
| ↑ | 25 | ↑ | 75 | 0.25 | 12.2 | 563 |
| ↑ | 0 | ↑ | 100 | 0.00 | 10.8 | 1015 |

TABLE 7

| First layer (CrFe) | | Second layer (CrFe) | | | | |
|---|---|---|---|---|---|---|
| Amount of | | Amount of | | Thickness Ratio | | |
| Fe added | Thickness | Fe added | Thickness | (First Layer Thickness/ | | TCR |
| [at. %] | [nm] | [at. %] | [nm] | Total Thickness) | Gf | [ppm/° C.] |
| 5.3 | 100 | 14.4 | 0 | 1.00 | 15.9 | −1021 |
| ↑ | 75 | ↑ | 25 | 0.75 | 13.5 | −738 |
| ↑ | 50 | ↑ | 50 | 0.50 | 10.4 | −254 |
| ↑ | 25 | ↑ | 75 | 0.25 | 8.1 | 104 |
| ↑ | 0 | ↑ | 100 | 0.00 | 5.7 | 521 |

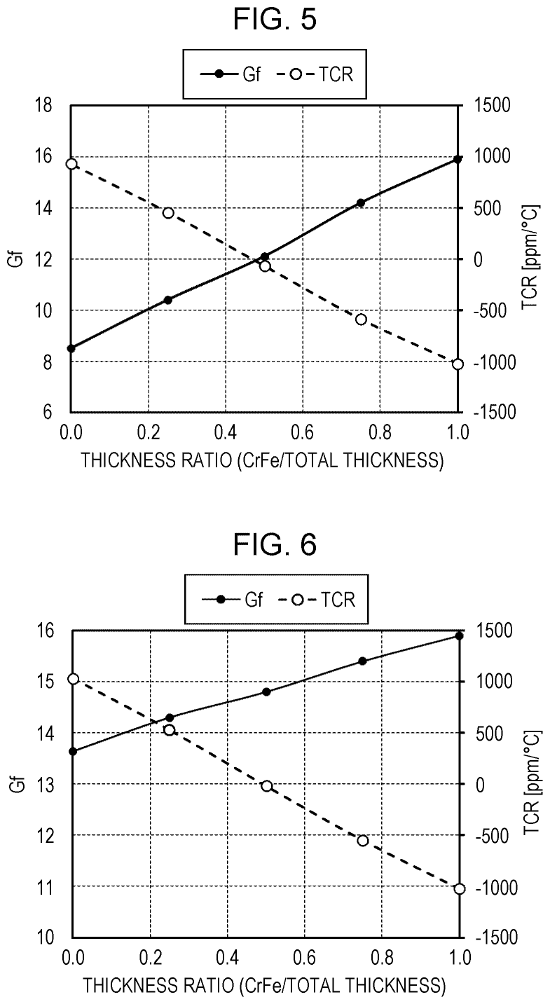

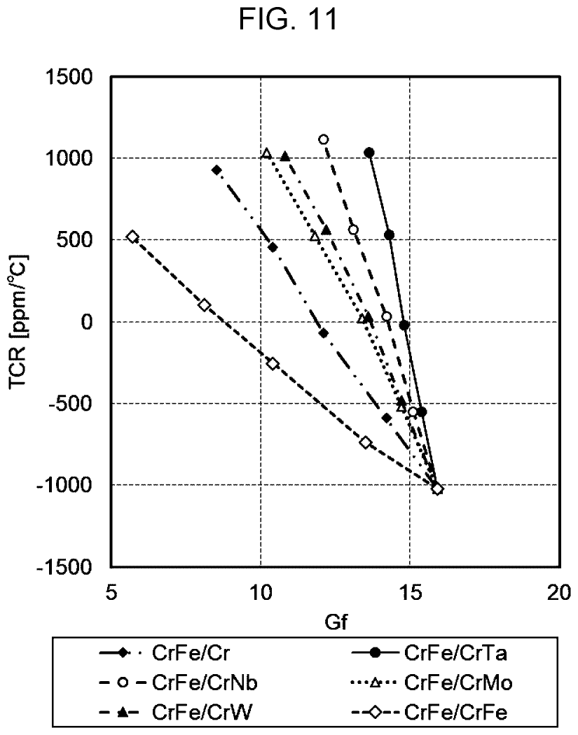

The properties of each strain gauge 10 were evaluated by using a sensor 100 that included the obtained strain gauge 10. The evaluation results are indicated in Tables 2 to 7. Moreover, based on the results in these tables, FIGS. 5 to 10 indicate the relationship between the gauge factor Gf and the temperature coefficient of resistance TCR as a function of the thickness ratio, and FIG. 11 indicates the relationship between the gauge factor Gf and the temperature coefficient of resistance TCR.

As indicated in Tables 2 to 7 and FIGS. 5 to 10, it was confirmed that a strain gauge 10 that had a strain resistor 12 including a first layer 121 and a second layer 122 could satisfy a gauge factor Gf of 10 or more and a temperature coefficient of resistance TCR in the range of ±1000 ppm/° C. It was also confirmed that the gauge factor Gf and the temperature coefficient of resistance TCR could be adjusted by adjusting the thickness ratio.

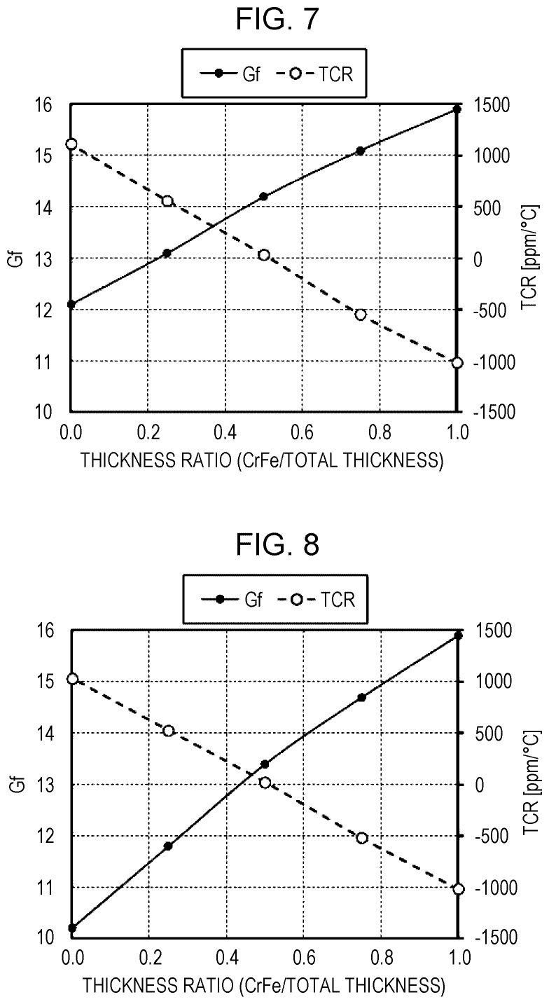

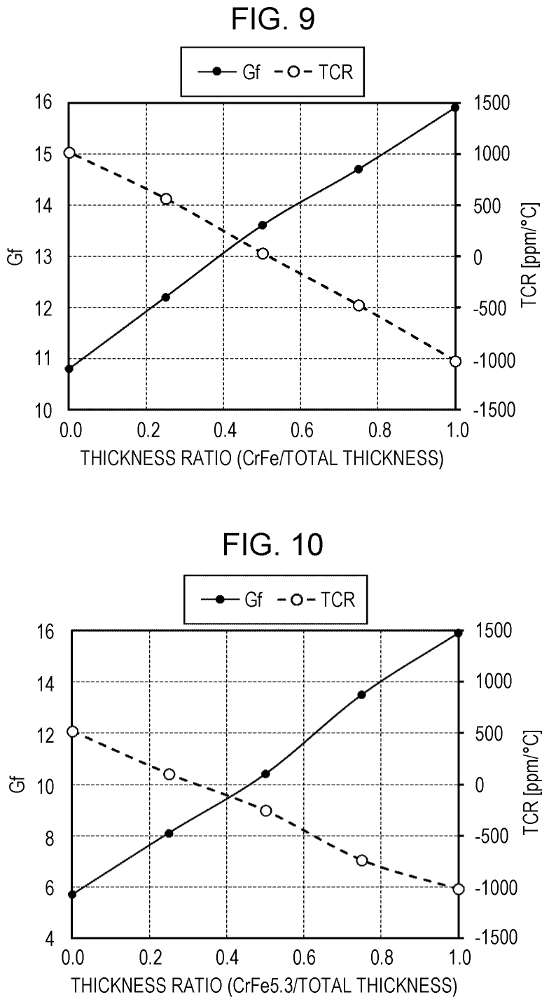

Specifically, the following matters were confirmed.
(1) Regarding Example 1, a gauge factor Gf of 10 or more and a temperature coefficient of resistance TCR in the range of ±1000 ppm/° C. can be satisfied when the thickness ratio is 0.2 or more on the basis of the tendency shown in FIG. 5 and when the thickness ratio is 0.25 or more and 0.75 or less on the basis of the measured values indicated in Table 2.
(2) Regarding Example 2, a gauge factor Gf of 10 or more and a temperature coefficient of resistance TCR in the range of ±1000 ppm/° C. can be satisfied when the thickness ratio is 0.05 or more and 0.95 or less on the basis of the tendency shown in FIG. 6 and when the thickness ratio is 0.25 or more and 0.75 or less on the basis of the measured values indicated in Table 3.
(3) Regarding Example 3, a gauge factor Gf of 10 or more and a temperature coefficient of resistance TCR in the range of ±1000 ppm/° C. can be satisfied when the thickness ratio is 0.05 or more and 0.95 or less on the basis of the tendency shown in FIG. 7 and when the thickness ratio is 0.25 or more and 0.75 or less on the basis of the measured values indicated in Table 4.
(4) Regarding Example 4, a gauge factor Gf of 10 or more and a temperature coefficient of resistance TCR in the range of ±1000 ppm/° C. can be satisfied when the thickness ratio is 0.05 or more and 0.95 or less on the basis of the tendency shown in FIG. 8 and when the thickness ratio is 0.25 or more and 0.75 or less on the basis of the measured values indicated in Table 5.
(5) Regarding Example 5, a gauge factor Gf of 10 or more and a temperature coefficient of resistance TCR in the range of ±1000 ppm/° C. can be satisfied when the thickness ratio is 0.05 or more and 0.95 or less on the basis of the tendency shown in FIG. 9 and when the thickness ratio is 0.25 or more and 0.75 or less on the basis of the measured values indicated in Table 6.
(6) Regarding Example 6, a gauge factor Gf of 10 or more and a temperature coefficient of resistance TCR in the range of ±1000 ppm/° C. can be satisfied when the thickness ratio is 0.45 or more and 0.95 or less on the basis of the tendency shown in FIG. 10 and when the thickness ratio is 0.5 or more and 0.75 or less on the basis of the measured values indicated in Table 7.

Furthermore, as indicated in FIG. 11, it was confirmed that the relationship between the gauge factor Gf and the temperature coefficient of resistance TCR could be adjusted by selecting the composition of the second layer 122.

What is claimed is:

1. A strain gauge comprising:
a strain resistor having a multilayer structure including:
a first layer composed of a Cr—Fe alloy, and
a second layer composed of Cr or a Cr-M alloy of Cr and M, M being at least one element selected from the group consisting of Fe, Nb, Mo, Ta, and W.

2. The strain gauge according to claim 1, wherein the first layer and the second layer each have a bcc structure.

3. The strain gauge according to claim 1, wherein an amount of Fe added in the Cr—Fe alloy constituting the first layer is 0.8 at. % or more and 11.2 at. % or less.

4. The strain gauge according to claim 1, wherein, when the second layer is composed of the Cr-M alloy but with M being other than Fe, an amount of M added is more than 0 at. % and 7.7 at. % or less.

5. The strain gauge according to claim 3, wherein, when the second layer is composed of a Cr—Fe alloy, an amount of Fe added in the second layer is either more than 0 at. % and less than 0.8 at. %, or more than 11.2 at. % and less than 14.4 at. %.

6. The strain gauge according to claim 1, wherein the strain gauge has a gauge factor Gf of 10 or more and a temperature coefficient of resistance TCR (unit: ppm/° C.) in a range of =500 ppm/° C.

7. A sensor comprising:
a substrate; and
the strain gauge according to claim 1, the strain gauge being disposed on the substrate,
wherein the strain gauge is used as detecting means.
